(19) United States
(12) Patent Application Publication
(10) Pub. No.: US 2006/0107762 A1
(43) Pub. Date: May 25, 2006

(54) Manually deformable input device

(76) Inventors: David Lee Sandbach, London (GB); Stuart Mark Walkington, Hertfordshire (GB); Kirsti Elina Lehtimaki, London (GB)

Correspondence Address: HARNESS, DICKEY & PIERCE, P.L.C., P.O. BOX 828, BLOOMFIELD HILLS, MI, 48303, US

(21) Appl. No.: 10/541,765

(22) PCT Filed: Jan. 9, 2004
(86) PCT No.: PCT/GB04/00060

§ 371 Date: Jul. 11, 2005

(30) Foreign Application Priority Data
Jan. 11, 2003 (GB) 0300683.0

(51) Int. Cl. G01L 1/16

(52) U.S. Cl. 73/862.68

(57) ABSTRACT

A manually deformable input device responsive to manually applied pressure. The input device comprises a deformable electroconductive material (602) configured to exhibit changes in conductance (resistance) in response to being stretched or compressed, from which an extent of manually applied pressure can be determined. An electrical interface device (604) is configured to supply electrical current through the electroconductive material (602) via a first terminal (605) and a second terminal (606), and the input device further comprises a third terminal (607) connected at a position intermediate the first and second terminals. The electrical interface device (604) is configured to receive a voltage from the third terminal (607), which is representative of a proportion of voltage drop across the electroconductive material (602). The input device operates as a potential divider sensitive to manual operation irrespective of the absolute conductance (resistance) of the electroconductive material (602).

### BACKGROUND OF THE INVENTION

1. Field of the Invention

The present invention relates to a manually deformable input device responsive to manually applied pressure. The input device may have control applications, such as controlling a motor or providing an input command to a game. Alternatively, the input device may be used to monitor conditions and, for example, to provide an output signal so as to raise an alarm condition.

2. Description of the Related Art

A deformation sensitive electroconductive device is disclosed in U.S. Pat. No. 4,715,235 in which a knitted or woven fabric has electroconductivity that changes in response to the fabric experiencing a deformation. In a detailed embodiment, a fabric is applied over a finger of an operative and finger movement is detected by detecting changes in the resistivity of the fabric. The fabric is modelled as a variable resistance and the resistivity of the fabric is measured in order to determine that a movement has been made.

A problem with fabrications of this type is that the resistive fabric element will undergo resistance changes in response to other changing conditions, such as temperature and ageing etc. such that its effective sensitivity significantly reduces the available applications for the device. Consequently, it is unlikely that the system described in the aforesaid US Patent could reach a satisfactory commercial realisation; other technologies being preferable for their inherent stability features.

It has been realised that fabric solutions do have advantageous application in some situations, particularly if costs are to be reduced or if the control mechanism is to be incorporated within soft structures or products. Thus, for example, it is possible that devices of this type could be used to make modifications to the position and orientation of seats in vehicles in preference to additional mechanical switches etc. Thus, in such an application, in preference to switches being operated manually, portions of a car seat itself could be manipulated so as to effect movement and reconfiguration. Such an approach may reduce production costs while providing a more elegant and attractive solution.

### BRIEF SUMMARY OF THE INVENTION

According to an aspect of the present invention, there is provided a manually deformable input device responsive to manually applied pressure, comprising a deformable resilient element configured to deform in response to said manually applied pressure, operatively coupled with an electroconductive material applied configured to exhibit changes in conductance (resistance) in response to being stretched; and an electrical interface device configured to supply electrical current through said electroconductive material via a first terminal and a second terminal, wherein, a third terminal is connected at an intermediate position; and said interface device is configured to receive a voltage from said third terminal.

According to a second aspect of the present invention, there is provided a deformable input device having an additional fourth terminal. The fourth terminal enables deformation of the input device to be detected in two dimensions.

According to a third aspect of the present invention, electroconductive material is operatively coupled to a three-dimensional deformable resilient element.

According to a fourth aspect of the present invention, there is provided a deformable input device in which the deformable resilient element and the electroconductive material are provided by an elastomeric electroconductive textile. By utilising a frame, a substantially two-dimensional manipulation area can be formed.

### BRIEF DESCRIPTION OF THE SEVERAL VIEWS OF THE DRAWINGS

FIG. 1 shows an electroconductive yarn;

FIG. 2 illustrates a weft knit;

FIG. 3 shows the weft knit of FIG. 2 following stretching;

FIG. 4 illustrates a relationship between resistance change and elongation;

FIG. 5 details a linear region identified in FIG. 4;

FIG. 6 shows a manually deformable input device embodying the present invention;

FIG. 7 illustrates the relationship between stretch and resistance of the device shown in FIG. 6;

FIG. 8 illustrates an electrical model of the device shown in FIG. 6;

FIG. 9 further illustrates the relationship between stretch and the resistance change for the device shown in FIG. 6;

FIG. 10 shows an alternative embodiment;

FIG. 11 shows a top view of the embodiment shown in FIG. 10;

FIG. 12 further illustrates the alternative embodiment of FIG. 10;

FIG. 13 details the interface circuit for the device shown in FIG. 10;

FIG. 14 illustrates the device of FIGS. 10 and 11 connected to the interface circuit shown in FIG. 13;

FIG. 15 shows an alternative embodiment of input device;

FIG. 16 shows an alternative embodiment of input device;

FIG. 17 further illustrates the alternative embodiment of FIG. 16;

FIG. 18 details procedures performed by the interface circuit for the embodiment shown in FIG. 16;

FIG. 19 shows an application of the device of FIG. 16;

FIG. 20 illustrates the configuration shown in FIG. 19 in use;

FIG. 21 illustrates an alternative application for a deformable input device;

FIG. 22 illustrates an alternative form of input device;

FIG. 23 illustrates a further alternative embodiment of input device;

FIG. 24 illustrates an alternative embodiment of input device;

FIG. 25 illustrates the input device of FIG. 24 following manipulation;

FIG. 26 illustrates an alternative embodiment of input device.

### WRITTEN DESCRIPTION OF THE BEST MODE FOR CARRYING OUT THE INVENTION

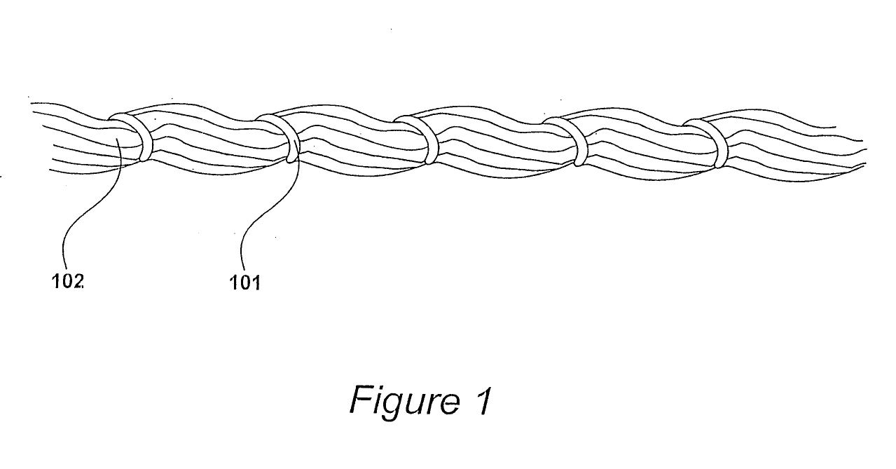

FIG. 1

An electroconductive yarn is shown in FIG. 1, constructed from an electrically conductive yarn 101 and an electrically insulating yarn 102. In this preferred embodiment, the electrically conductive yarn 101 is wrapped around the insulating yarn 102. The conductive yarn may be fabricated from a conventional yarn having a carbonised or metallised outer surface and the insulating yarn 102 may be fabricated from polyester. In this example, the conductive yarn 101 has a size of twenty-four decitex whereas the insulating yarn 102 has a size of twelve decitex. According to a preferred embodiment, six filaments of twenty four decitex carbon coated nylon are twisted together with twelve filaments of twelve decitex polyester yarn. By using conducting yarn having a diameter greater than the insulating yarn, the twisted composite yarn can be formed with prominent conductive elements at the surface.

It can be appreciated that an electrical current may flow down the conductive yarn 101. In addition, when yarns are in close proximity, or loops of the same yarn are in close proximity, a current may also flow between the yarns or loops. Furthermore, when yarns are in close proximity planar resistance tends to reduce, whereas forcing the yarns away from each other, by a stretching operation for example, results in the overall planar resistance increasing.

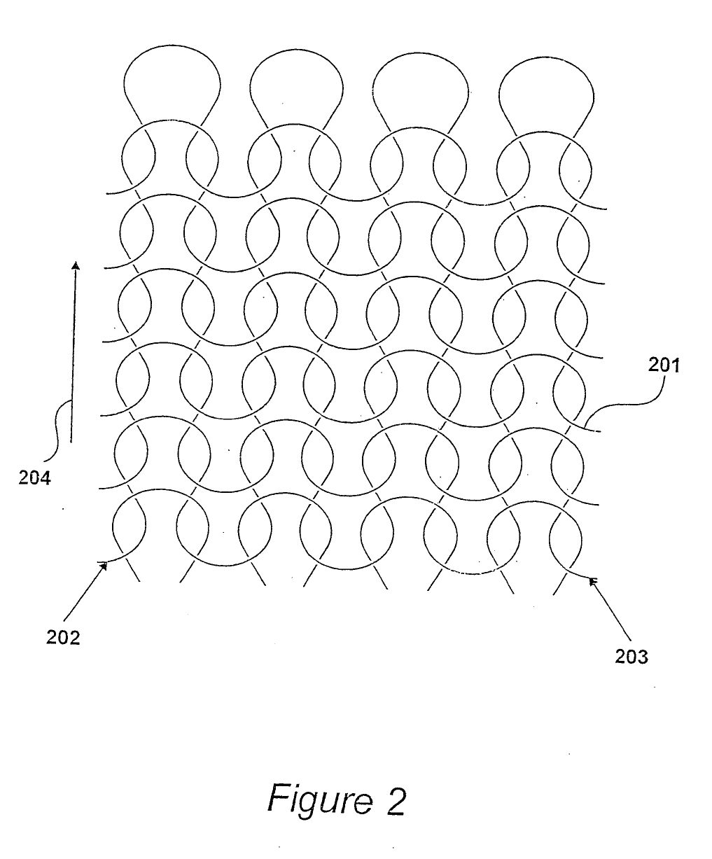

FIG. 2

A construction that emphasises the effect of resistance changes with respect to stretch is illustrated in FIG. 2. This consists of a weft knit where individual yarns 201 run from a left position 202 to a right position 203. In, a preferred application, a voltage is applied across the plane so as to promote current flow in the direction of arrow 204; that is to say substantially perpendicular to the direction of the individual conducting yarns, i.e. in the warp direction.

An electroconductive fabric that exhibits a change of resistance in response to stretching can be created using other constructions including warp knit, weave and crochet constructions; and may incorporate composite yarn, such as the conductive yarn shown in FIG. 1, yarn comprising staple or monofilament fibres, or elastic fibres, for example in a yarn having conductive or insulating fibres wrapped around an elastic centre. In addition, conductive yarn and insulating yarn may be twisted together prior to the construction process or, for example, conductive yarn can be incorporated during the construction process. Thus, electroconductive materials with different characteristics can be created using different constructions, materials and, for example, stitch sizes.

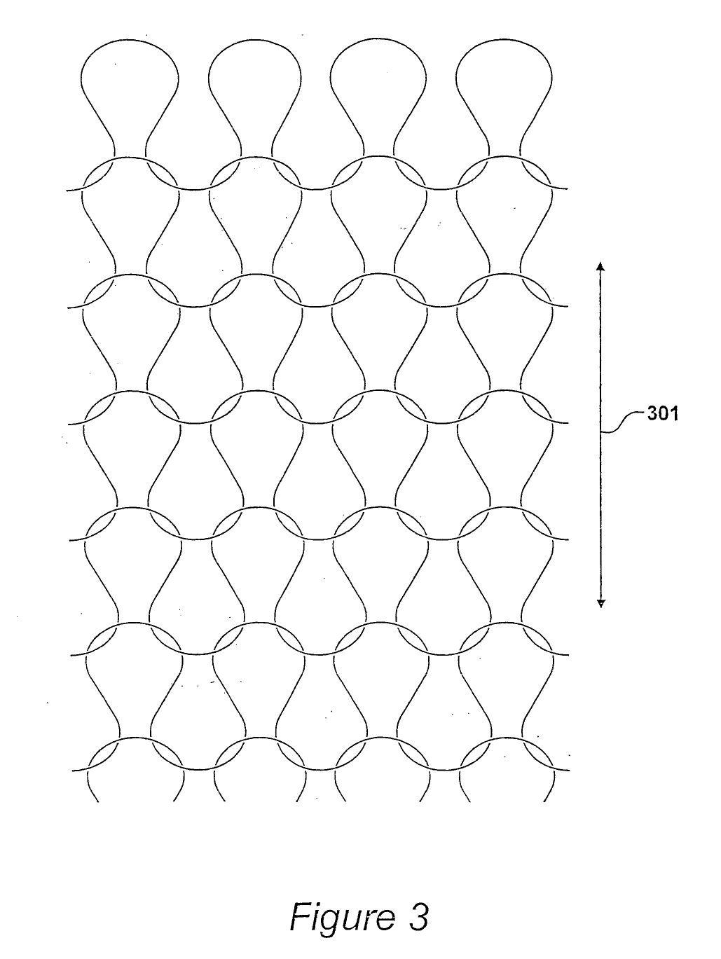

FIG. 3

The weft knit construction illustrated in FIG. 2 is also shown in FIG. 3, after the material has been stretched in the direction illustrated by arrow 301. This has resulted in an increase in the separation between the individual yarns such that fewer paths now exist for current flow and hence the planar resistance has increased. Thus, it is possible for this property to be used in order to determine the extent of stretch which in turn may be related back to an extent of manually applied pressure.

According to an alternative warp knit construction (not shown) conductive in the warp direction, the planar resistance decreases in response to stretching in the warp direction. Thus, although this type of construction responds differently to the described weft knit construction shown in FIGS. 2 and 3, it possesses the same property of exhibiting a change in resistance in response to being stretched, from which an extent of manually applied pressure can be determined.

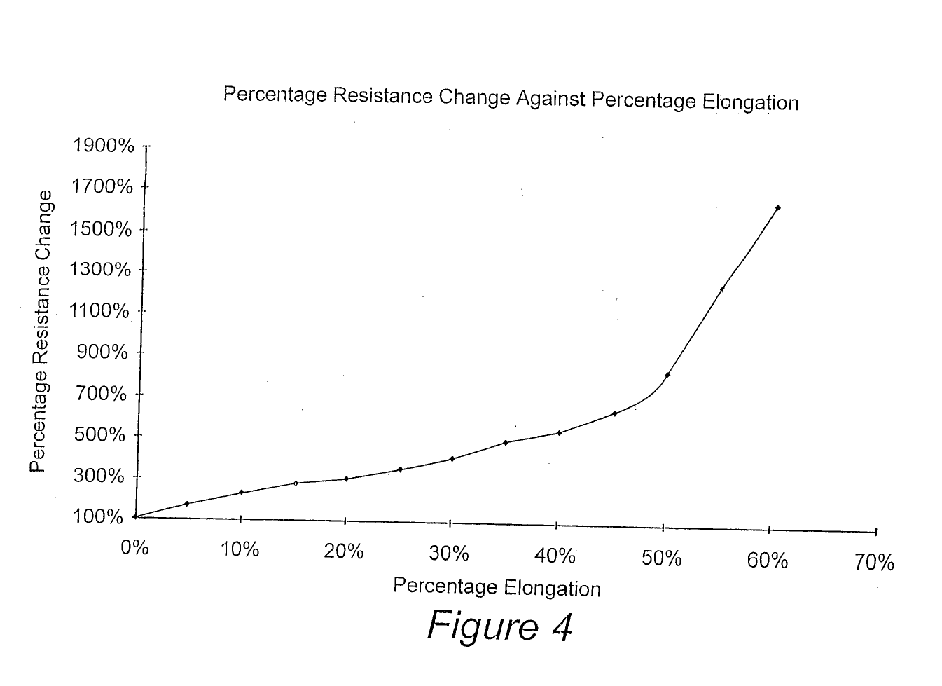

FIG. 4

A relationship between resistance change and sheet elongation is illustrated in FIG. 4. It can be seen from FIG. 4 that for the weft knit fabric shown in FIGS. 2 and 3, a percentage increase of elongation of approximately forty percent results in a resistance change of approximately five hundred percent. Furthermore, for elongations between zero and forty percent the increase in resistance is relatively linear. For elongation beyond forty percent the relationship tends to become non-linear. Thus, the linear portion provides a preferred operational region for control purposes.

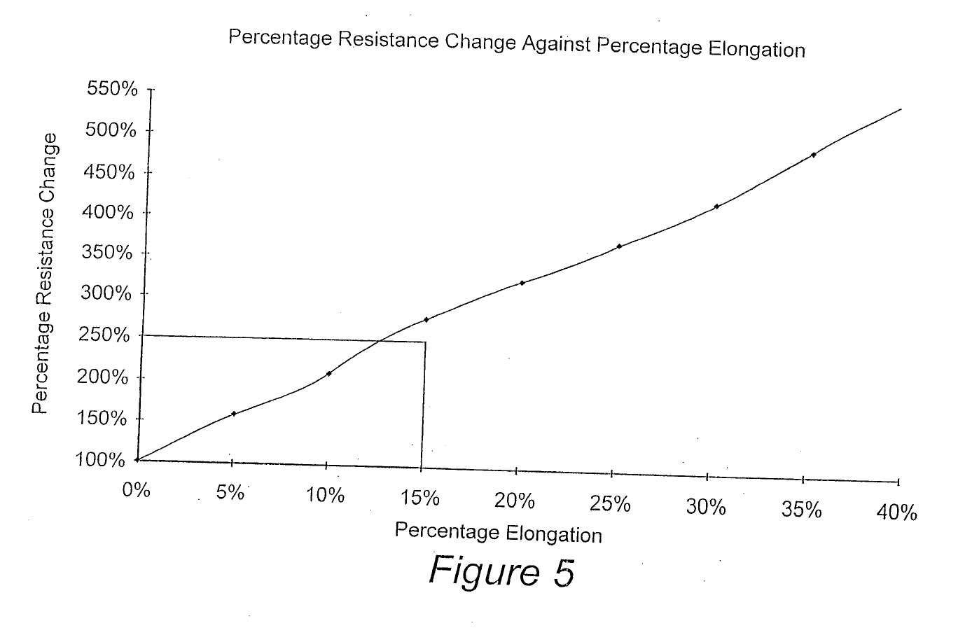

FIG. 5

The linear region of operation identified in FIG. 4 is detailed in FIG. 5. Thus, by measuring resistance change it is possible to identify percentage elongations over a range of zero to forty percent.

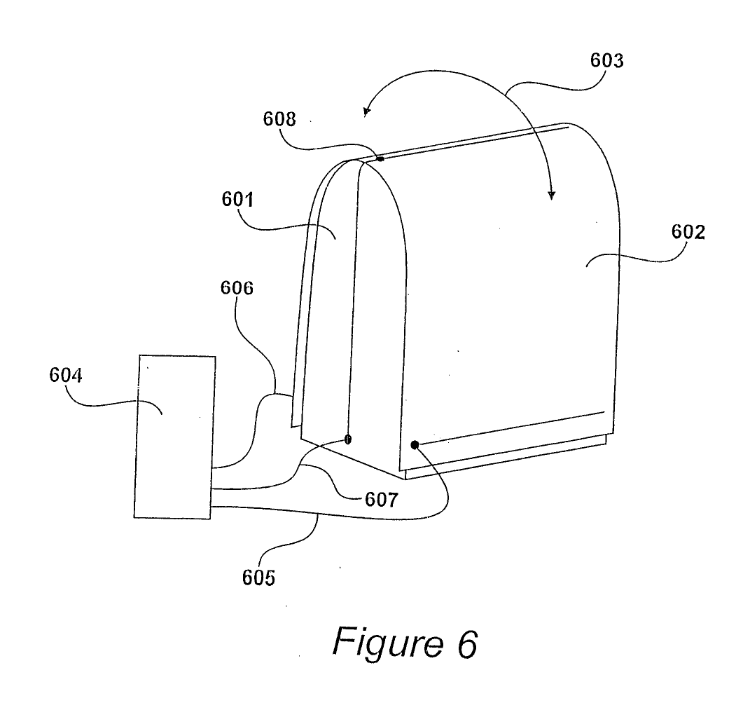

FIG. 6

A manually deformable input device responsive to manually applied pressure is detailed in FIG. 6. The device includes a deformable resilient element 601. Resilient element 601 may be fabricated from closed cell foam, elastomeric silicone rubber or similar elastomeric materials. The deformable element 601 is covered with an electroconductive material 602 Such as the weft knit material illustrated in FIG. 2. Thus, electroconductive material 602 is configured to exhibit changes in conductance (resistance) in response to being stretched.

Stretching occurs locally by moving the resilient element 601 in the directions illustrated by arrow 603, which results in one side of the device experiencing elongation while the opposite side of the device experiences compression. Alternatively, stretching occurs when pressure is applied to a region of the deformable element 601, for example a discrete region on one side of the deformable element 601 only, which results in deformation of one side of the deformable element 601 relative to the other. In addition, the electroconductive material 602 has a thickness that is responsive to manually applied pressure. A relationship exists between the thickness and the conductivity of electoconductive material 602, such that a change in the thickness of the material 602 under manually applied pressure results in a corresponding change in conductivity. Thus, electroconductive material 602 is responsive to different types of manipulation of the resilient element 601 it is to be appreciated that the electroconductive material is operatively coupled to the deformable resilient element. The electroconductive material is therefore responsive to deformation experienced by the resilient element.

An electrical interface device 604 is configured to supply electrical current via a first terminal 605 and a second terminal 606. Thus, with a current flowing from one terminal to the other, the resistance of the electroconductive material 602 results in a voltage drop occurring between the two terminals.

A third terminal 607 is connected at an intermediate position 608, along the conductive fabric, between the first and second terminals 605, 606. The interface device 604 receives a voltage from the third terminal 607, representing a proportion of the voltage drop occurring through the electroconductive material. Thus, in this way, the third terminal 607 provides a tap into the voltage gradient, in the present example at the central intermediate position 608. The total configuration therefore operates as a potential divider sensitive to manual operation irrespective of the absolute resistance of the overall electroconductive fabric. Thus, in this way, it is possible to obtain significantly higher levels of sensitivity and predictability such that the mechanism may be used in many control situations where known technologies, merely directed towards measuring resistance per se, would not be applicable.

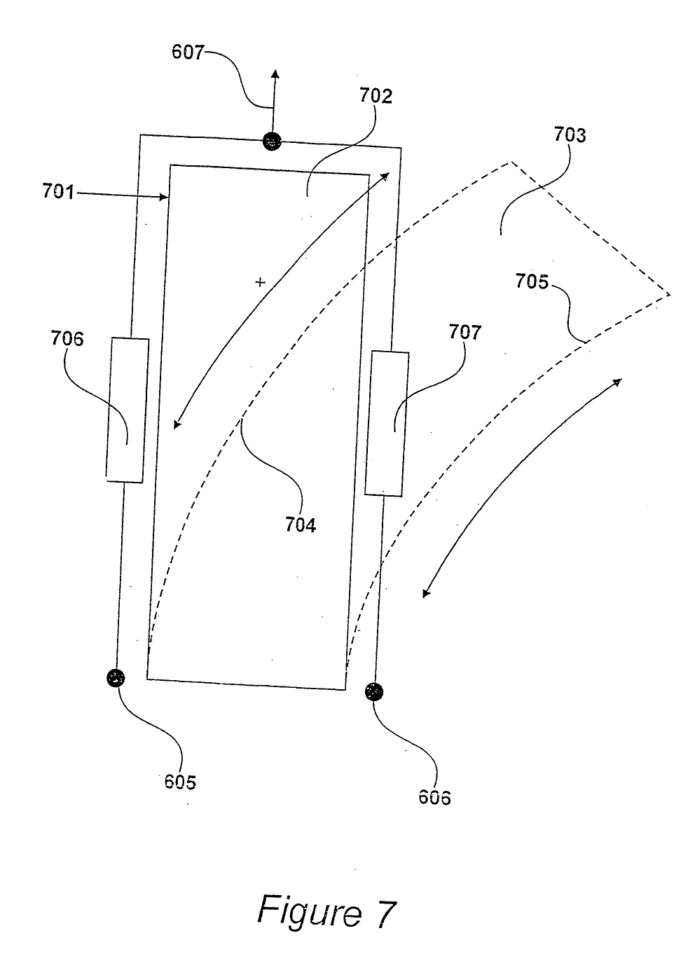

FIG. 7

The relationship between stretch and resistance, for the device shown in FIG. 6 is illustrated in FIG. 7. When force is applied in the direction of arrow 701, the device is elastically forced from the position shown at 702 to, for example, a position shown at 703. This results in a left wall 704 being elongated while a right wall 705 is compressed.

An electromotive force of three volts is applied across terminals 605 and 606. Before a manual force is applied, resistances 706 and 707 will tend to be substantially equal such that the voltage appearing at the third terminal 607 will tend to be 1.5 volts; i.e. the voltage is being divided substantially equally. As force is applied, resulting in the device being bent towards position 703, the compression applied to resistance 707 will tend to reduce resistance whereas the extension applied to resistance 706 will tend to increase its resistance. With the resistance at 706 being increased, there will tend to be a greater voltage drop across this resistance with a relatively lower voltage drop occurring across resistance 707. Thus, for example, when stretched to position 703, two volts may be measured at the third terminal 607. Thus, detecting a voltage change from 1.5 volts to 2 volts over the linear period of operation, as illustrated in FIG. 5, allows a relatively accurate measurement to be determined as to the extent of bending that has occurred between positions 702 and 703. In this way, the input device is responsive to tensile forces.

Due to the operative coupling between the resilient element and the electroconductive material, following release of applied pressure resulting in deformation of the input device, the resilient element and the electroconductive material are together returned into the unbent condition.

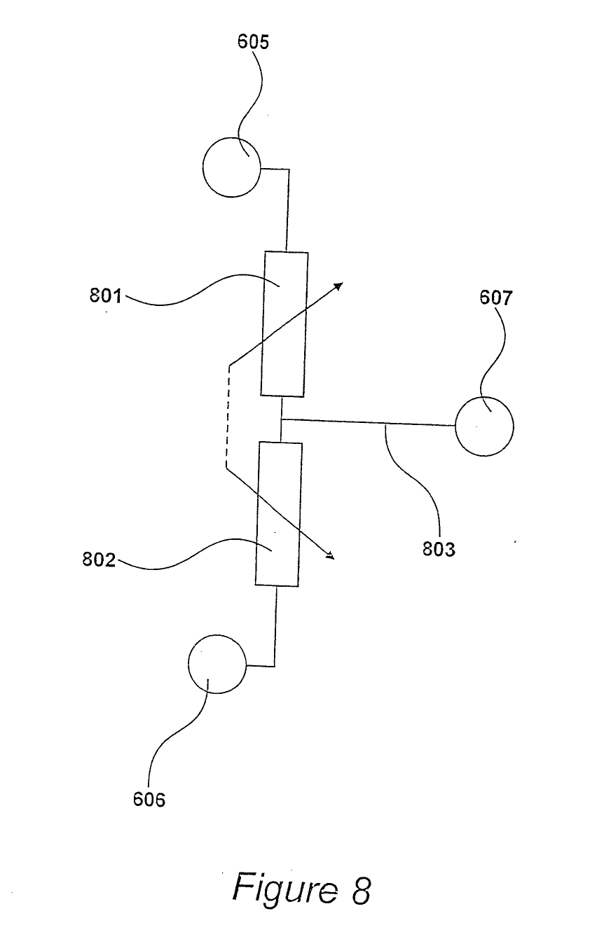

FIG. 8

An electrical model of the device shown in FIG. 6 is illustrated in FIG. 8. This consists of a first variable resistor 801 in series with a second variable resistor 802. A central tap 803 completes the potential divider. Thus, as previously described, a voltage is applied across terminals 605 and 606 and the divided voltage is measured at the third terminal 607 via tap 803.

The nature of the device is such that the variable resistors 801 and 802 may be considered as being ganged. However, an inverse relationship typically exists between the variable resistors such that an operation to increase the resistance of one will normally result in a decrease of the resistance of the other. However, it should be appreciated that in the actual device relative rates of change will differ. Consequently, bending of the device will tend to increase the resistance of the stretched resistor to a greater extent than a decrease in the resistance of the compressed resistor. Thus, the configuration provides a potential divider that appears similar to a potentiometer but has somewhat different operational characteristics. For example, a change in the magnitude of one resistance may be exhibited while the magnitude of the other resistance may be substantially maintained.

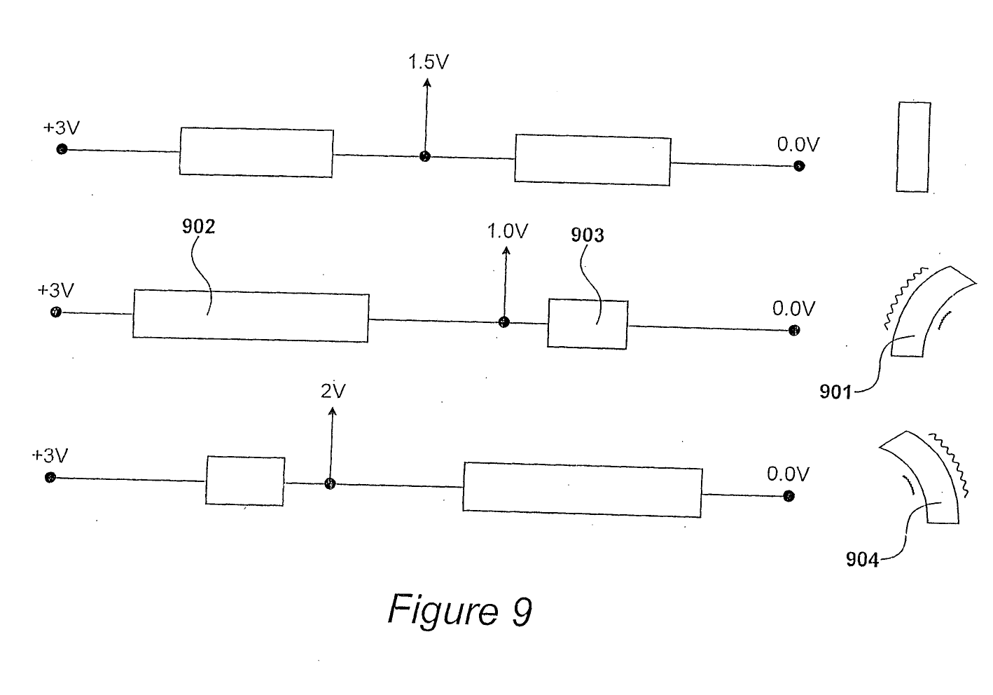

FIG. 9

A further representation of the relationship between resistance changes and bending is illustrated in FIG. 9. In its unbent condition, each side of the conductive fabric displays a resistance of five thousand ohm (5 k) and the applied voltage of three volts is divided equally. Consequently, the voltage measured at the third terminal is substantially 1.5 volts.

As the device is bent to the right, as shown at 901, the stretched resistance 902 will tend to increase and the compressed resistance 903 will tend to decrease. Thus, a greater voltage drop will occur across resistance 902 resulting in the tapped voltage reducing from 1.5 volts to one volt.

Similarly, if the device is bent to the left, as illustrated at 904, resistance 902 will tend to decrease while resistance 903 will tend to increase. Consequently, in this example, the tapped voltage has increased from 1.5 volts to two volts.

However, the present invention provides a manually deformable input device that is responsive to other forms of manipulation. Different patterns of voltage change can be related to different types of manipulation and device structure. For example, a manually deformable input device having the electrical configuration of the device shown in FIG. 6 can be utilised within a car seat cushion, in which the cushion is supported on the underside by a substantially rigid panel, and the topside is exposed to allow manual manipulation of the cushion. With this arrangement, the cushion deforms under the weight of a person sitting upon it, however, deformation of the underside of the cushion is negligible relative to the deformation of the topside of the cushion. Consequently, a significantly greater change in conductivity of the topside of the cushion, compared to the underside, occurs. Thus, a change in conductivity of the topside relative to the underside is exhibited, from which deformation can be detected. In this example, the detected deformation is primarily compression or indentation in nature, resulting from, for example, a person pressing the cushion with a finger.

Such a cushion may comprise a single manually deformable input device, or may comprise a plurality of such devices, such that deformation in different areas of the cushion can be detected. Such a cushion can be utilised as a control or control panel, or as a monitoring aid to monitor, for example, the length of time a person is sitting, the frequency of use of a seat, or the sitting position of one or more persons.

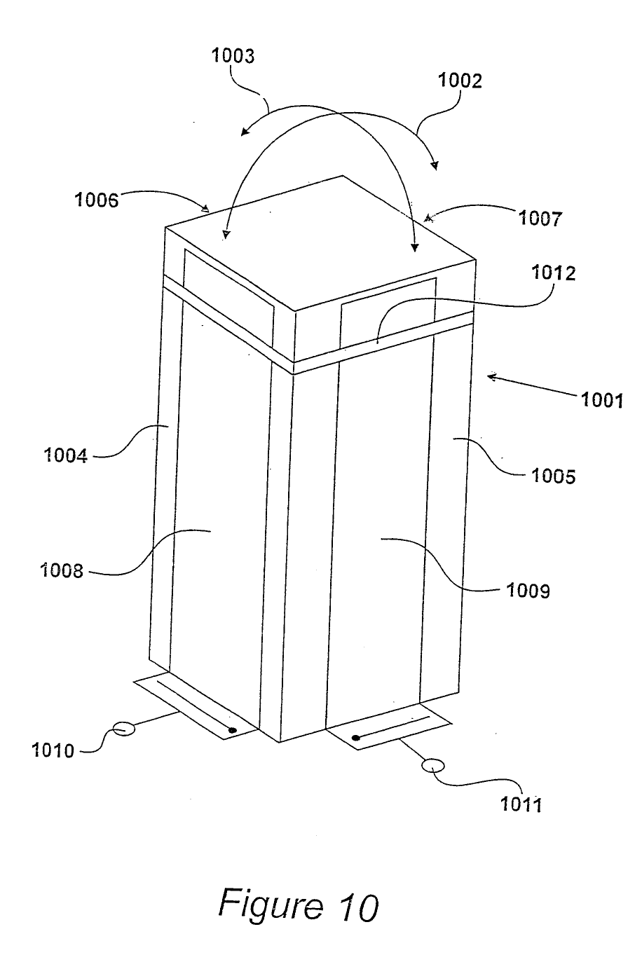

FIG. 10

An alternative embodiment is illustrated in FIG. 10. A deformable resilient element 1001 is responsive to deformation in two dimensions, illustrated by a first arrow 1002 and a second arrow 1003. The device has a substantially square cross-section defining four surfaces; a first 1004 and a second 1005 surface are shown in the Figure, with a third 1006 and a fourth surface 1007 being on the reverse side. Each surface 1004 to 1007 has an electroconductive fabric portion applied thereto; shown in FIG. 10 is fabric 1008 applied to surface 1004 and fabric 1009 applied to surface 1005. An electrical terminal is connected to the bottom of each conductive fabric 1004 to 1008; shown in FIG. 10 is terminal 1010 applied to conductive fabric 1008 and terminal 1011 applied to conductive fabric 1009. The conductive fabrics are electrically connected towards the top of the device, in this example by means of a conductive band 1012. Other connection means include adhering or stitching the conductive portions together directly or via a conductive ring.

According to the present embodiment, to simplify construction of the deformable input device, a separate third terminal voltage dividing tap is not provided. In operation, current is applied through opposing conductive portions while a third portion, on one of the other two surfaces, provides the voltage dividing tap. By scanning pairs of opposed conducting surfaces in alternating sequence, deformation in the two illustrated dimensions can be detected. Thus, this mode of operation in effect utilises two potential dividers. Using similar conductive material on each surface of a pair offsets effects resulting from changes in temperature, humidity etc.

According to an alternative embodiment, a separate voltage dividing tap connected to conductive band 1012 is provided. According to a further alternative embodiment, two manually deformable input devices according to the embodiment described with reference to FIGS. 6 to 8 are placed upon deformable resilient element 1001, such that deformation can be detected in the two illustrated directions, and two separate voltage dividing taps are provided.

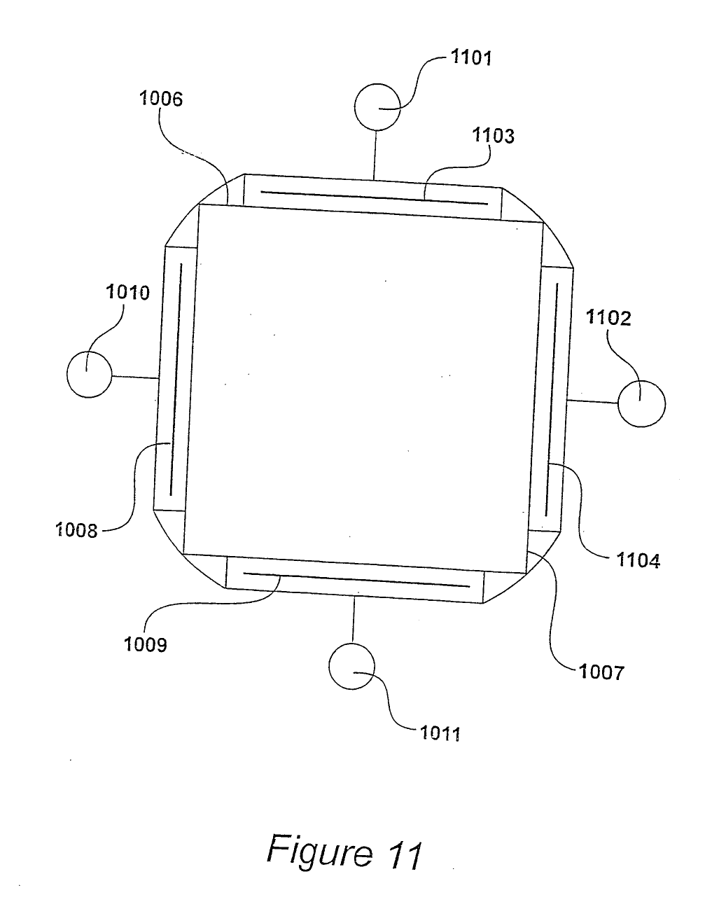

FIG. 11

A top view of the device illustrated in FIG. 10 is shown in Figure II. In addition to terminals 1010 and 1011 (shown in FIG. 10) terminals 1101 and 1102 are also shown in FIG. 11. Terminal 1010 is connected to conductive fabric 1008 and terminal 1011 is connected to conductive fabric 1009. Similarly, terminal 1101 is connected to conductive fabric 1003 and terminal 1102 is connected to conductive fabric 1004; applied to vertical surface 1006 and 1007 respectively.

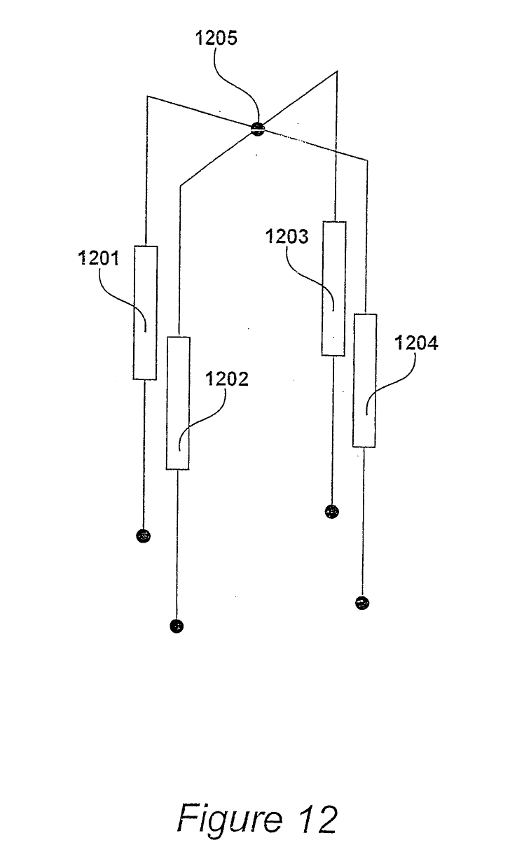

FIG. 12

An electrical representation of the configuration shown in FIGS. 10. and 11 is illustrated in FIG. 12. This consists of four variable resistors 1201, 25 1202, 1203 and 1204 each connected to a central point 1205.

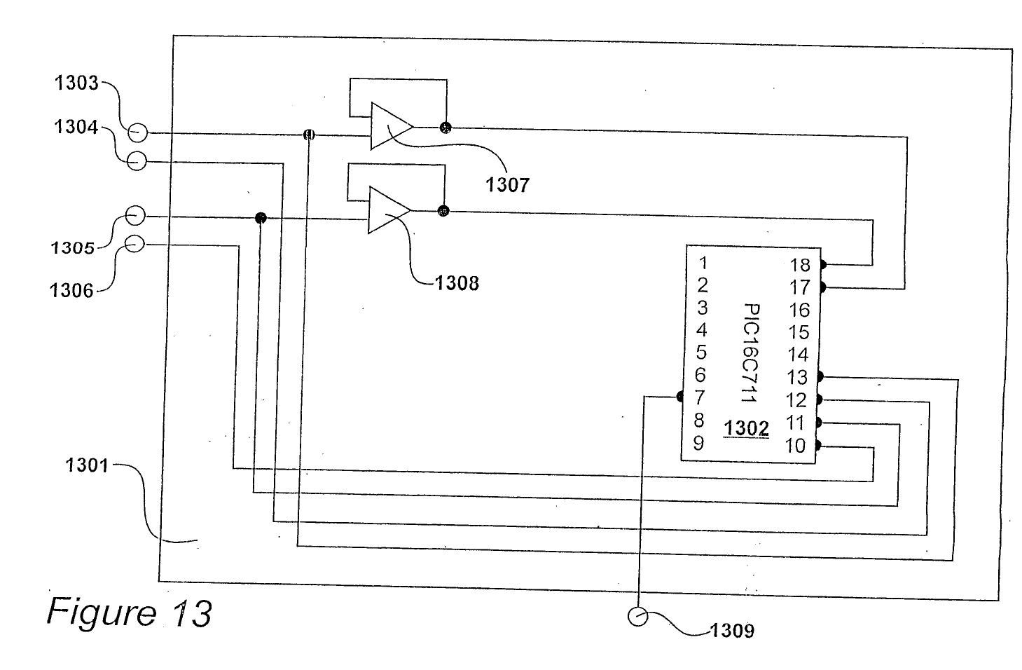

FIG. 13

An interface circuit 1301 for the device shown in FIGS. 10 and 11 is shown in FIG. 13. The interface circuit includes a PIC processor 1302 configured to supply output signals to terminals and to receive input signals from terminals. The device includes four interface terminals 1303, 1304, 1305 and 1306. Terminal 1303 connects to 1010, terminal 1304 connects to 1011, terminal 1305 connects to terminal 1102 and terminal 1303 connects to terminal 1101.

Under program control, output voltages are generated by the processor 1302, from pins ten, eleven, twelve and thirteen. Similarly, input voltages are received at pins seventeen and eighteen via buffer amplifier stages 1307 and 1308. In operation, voltage is applied across terminals 1303 and 1305 resulting in a voltage being applied across terminals 1010 and 1102. A voltage is received at terminal 1305 and supplied to the PIC processor via amplifier 1308. This is then followed, in a multiplexed fashion, by a voltage being applied across terminals 1304 and 1305 such that an input voltage may be received on terminal 1303 and supplied to the PIC processor via buffer amplifier 1307. Response details are stored within the PIC processor 1302 thereby allowing it to produce an output signal on an output terminal 1309 indicative of the degree of manipulation, for example, bending.

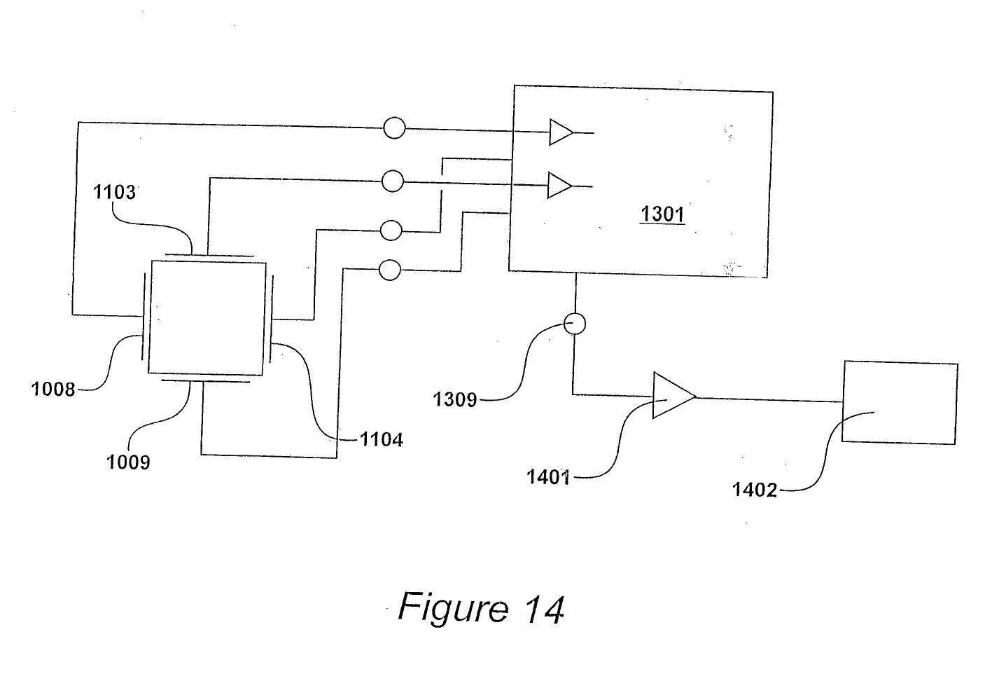

FIG. 14

The input device of FIGS. 10 and 11 is shown connected to the interface circuit of FIG. 13 in FIG. 14. The interface circuit 1301 applies a voltage across surfaces 1008 and 1104 whereafter a tapped input voltage is received from surface 1103 and applied to input terminal 1305. After an input measurement has stabilised, the output voltage is removed to be replaced by an alternative output voltage across surfaces 1009 and 1103. Subsequently, an input voltage is received from surface 1008 and applied to input terminal 1303.

The PIC processor performs appropriate calculations to determine the nature of the displacement of the device to provide an output signal at terminal 1309. In this example, the output signal is supplied to a power amplifier 1401 which in turn drives an actuator 1402. The actuator could, for example, be a motorised car seat adjustment motor or any other appropriate device controlled by manipulation of the input device.

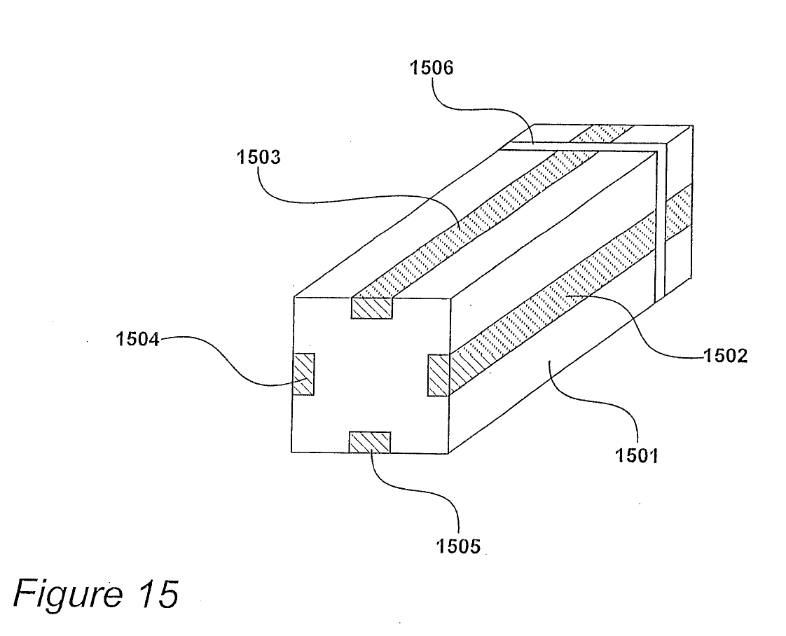

FIG. 15

An alternative embodiment similar to the embodiment shown in FIG. 10 is identified in FIG. 15. In this embodiment, a deformable resilient element 1501 is implemented by insulating foam. Four strips of electroconductive material 1502, 1503, 1504 and 1505 are implemented by electroconductive foam. As shown, the conductive foam is embedded within the deformable resilient element. The conductive foam is substantially similar to the insulating foam but includes particles or fibres of conducting material. Consequently, when stretched, the conducting components are placed in a condition of greater separation thereby increasing overall resistance. Similarly, compression brings more of the conductive components together and therefore increases conduction. Alternative electroconductive materials include other insulating materials such as silicon or rubber filled with conducting particles or fibres. The electroconductive material may itself display resilience, for example in the instance where an electroconductive material is provided by an elastomeric insulating material incorporating conducting particles or fibres.

As shown in FIG. 15, a conductive band 1506 electrically connects the conductive foam sections 1502 to 1505 at a top end with the bottom end of the conductive foam sections being connected by electrical terminals to an interface circuit substantially as illustrated in FIG. 14.

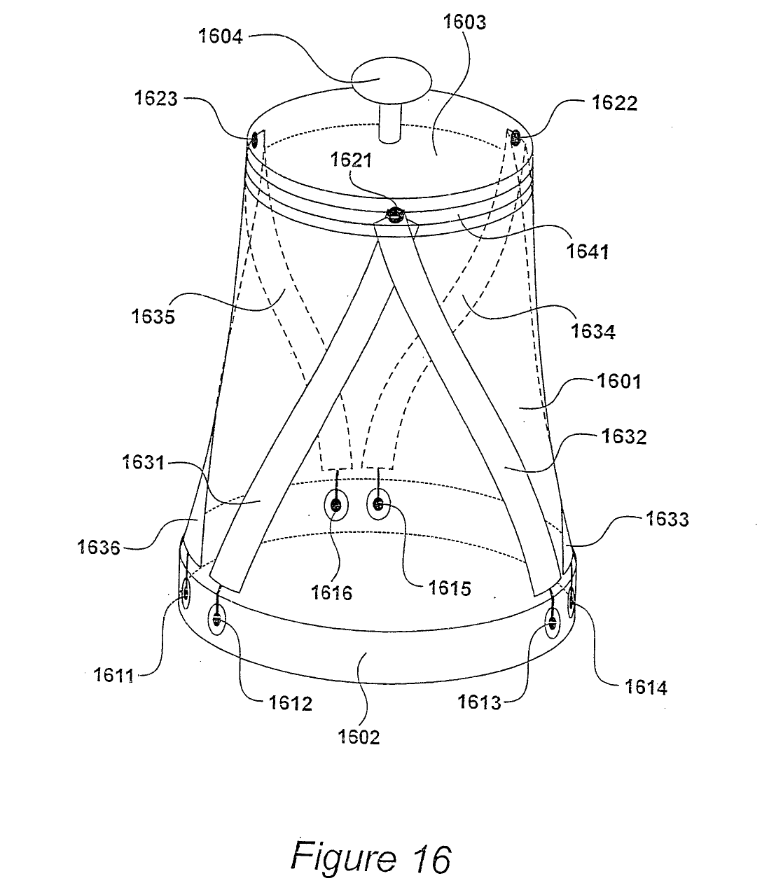

FIG. 16

An alternative embodiment of deformable input device is shown in FIG. 16, capable of detecting movement in all six degrees of freedom; namely translation in the X, Y and Z directions along with rotation about the X, Y and Z axes. A deformable resilient element 1601 is substantially frusta-conical, with its larger substantially circular base 1602 being firmly attached to a substrate such that it is firmly held into position on a table top or similar structure. An upper surface 1603 of the resilient element 1601 has an extension portion 1604 extending therefrom to facilitate manual manipulation.

Six electroconductive material portions are applied over the deformable resilient element 1601 in a substantially diagonal configuration running from a first lower electrical connector to an upper joint and then returning to a further lower connector. The combination therefore has a total of six lower connectors 1611, 1612, 1613, 1614, 1615 and 1616. The upper joints are displaced centrally between the lower connectors at upper joint locations 1621, 1622 and 1623. A first variably conductive material section 1631 is positioned between lower connector 1612 and upper joint 1621. A second variably conductive material section 1632 is applied between upper joint 1621 and lower connector 1613. Similarly, a third variably conductive material section 1633 is positioned between lower connector 1614 and upper joint 1622, and a fourth variably conductive material section 1634 is positioned between upper joint 1622 and lower connector 1615. A fifth variably conductive material section 1635 is positioned between lower connector 1616 and upper joint 1623, and finally, a sixth variably conductive material section 1636 is positioned between upper joint 1623 and lower connector 1611. Upper joints 1621 to 1623 are electrically connected by a conductive band 1641. In this example, conductive band 1641 comprises metallised woven fabric and is connected using pressure sensitive conductive adhesive. Thus, it is possible to supply current through sections 1631 and 1632 by the application of a voltage across connectors 1612 and 1613. Similarly, it is possible to apply a current through sections 1633 and 1634 by the application of a voltage across connectors 1614 and 1615. Finally, a current may also flow through sections 1635 and 1636 by the application of a voltage across connectors 1616 and 1611.

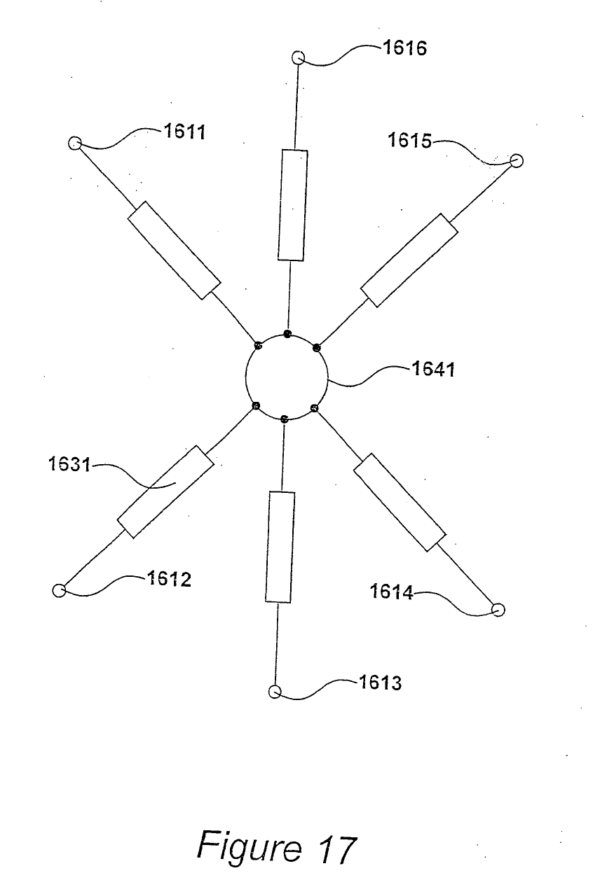

FIG. 17

An electrical model for the configuration of FIG. 16 is shown in FIG. 17. In the model shown in FIG. 17, six variable resistors are commonly connected at 1641 and each present a terminal 1611 to 1616.

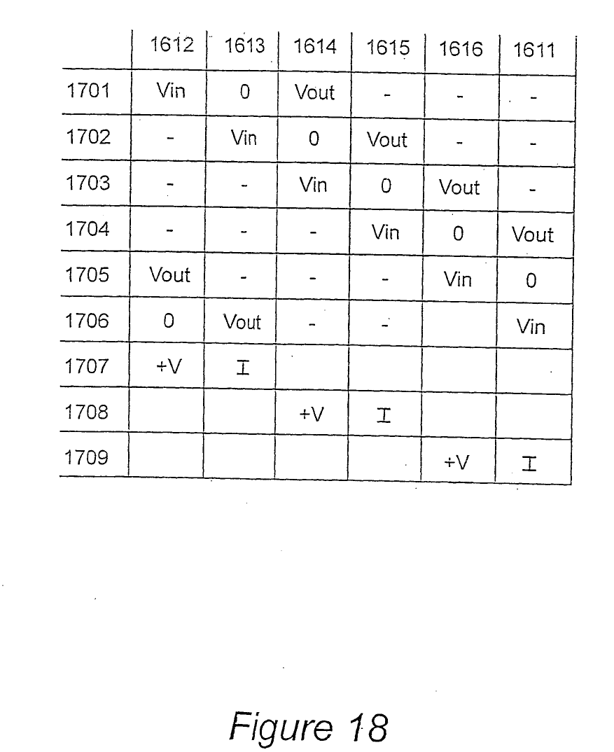

FIG. 18

The input device of FIG. 16 is connected to an interface device substantially similar to that shown in FIG. 13, but with additional input/outputs and current measuring means. The current measuring means may comprise a fixed resistor connected to, for example, each of connectors 1611, 1613 and 1615, that can be switched to and from ground. Procedures performed by the interface device are multiplexed, as illustrated in FIG. 18. Thus, an energising cycle consists of nine stages 1701 to 1709. Stages 1701 to 1706 involve voltage measurement, whereafter sufficient information has been received in order to define a three-dimensional movement of the deformable element within six degrees of freedom. The information can be processed in accordance with known systems, such as Stewart bridge analysis. Stages 1707 to 1709 involve current measurement, whereafter sufficient information has been received in order to identify compression or indentation of the deformable element.

At step 1701 a voltage is applied to connector 1612. Connector 1613 is grounded and an output voltage is measured at connector 1614. It is possible, however, to apply a voltage across connectors 1612 and 1613 and to connect an input buffer with high input impedance to connector 1614 or any other connector that is otherwise unused during this measurement, and to measure voltage at conducting band 1641. At step 1702 an input voltage is applied to connector 1613, connector 1614 is grounded and an output voltage is measured at connector 1615. At step 1703 an input voltage is applied to connector 1614, connector 1615 is grounded and an output voltage is measured at connector 1616. At step 1704 an input voltage is applied at connector 1615, connector 1616 is grounded and an output voltage is measured at connector 1611. At step 1705 an input voltage is applied to connector 1616, connector 1611 is grounded and an output voltage is measured at connector 1612. Voltage measurement is completed, at step 1706, by an input voltage being applied to connector 1611, connector 1612 being grounded and an output voltage being measured at connector 1613.

Steps 1707 to 1709 involve current measurement. At step 1707 a voltage is applied to. connector 1612 and a current is measured at connector 1613. At step 1708 a voltage is applied to connector 1614 and the current is measured at connector 1615. Finally, at step 1709 a voltage is applied to connector 1616 and a current is measured at connector 1611.

The resistance of the six variably conductive material sections 1631 to 1636 either increase or decrease, according to the construction of the material, in response to the deformable element deforming under an applied squeezing action. The current measurements performed at steps 1707 to 1709 provide an indication as to the current flowing through the deformable element, which may be related to an extent of pressure applied to the deformable element. Thus, steps 1707 to 1709 provide for a squeezing, compressing or denting action applied to the deformable element to be detected, and hence compression or indentation of the deformable element to be detected.

The multiplexed procedure sequence detailed in FIG. 8 can be executed according to one of two modes, namely monitoring mode and active mode. In monitoring mode, steps 1701 to 1706 are performed at a first scan rate to minimise power consumption, and when motion is detected, steps 1701 to 1709 are performed at a second faster scan rate in active mode, during which full sets of measurements are obtained.

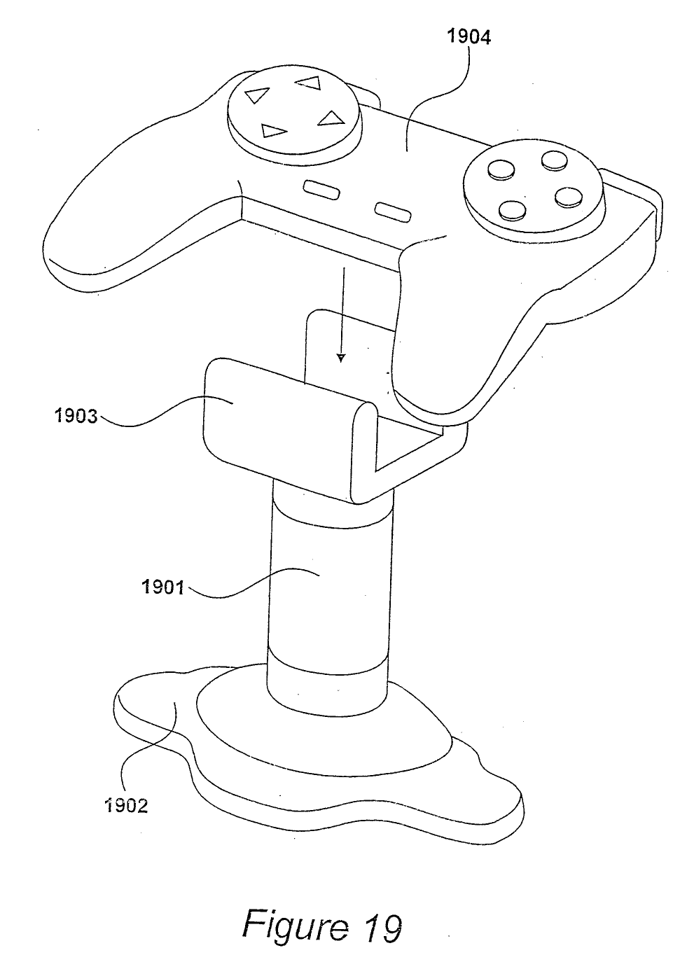

FIG. 19

An application for a device of the type shown in FIG. 16 is shown in FIG. 19. A portable deformable input device 1901 is attached to a base plate 1902, configured to be supported by a solid object. A clamp 1903 has been attached to the top of the deformable input device 1901 configured to receive a manually-operable games controller 1904. Thus, with the games controller 1904 being supported within the clamp 1903 it is possible for a game player to provide additional information to an appropriately programmed game. Thus, for example, a configuration of this type would be particularly suitable for 3D action games and flight simulators etc. In addition to receiving an input from the controller 1904 a computer system also receives an input from an interface device associated with the deformable input device 1901 possibly over a serial or a USB computer interface.

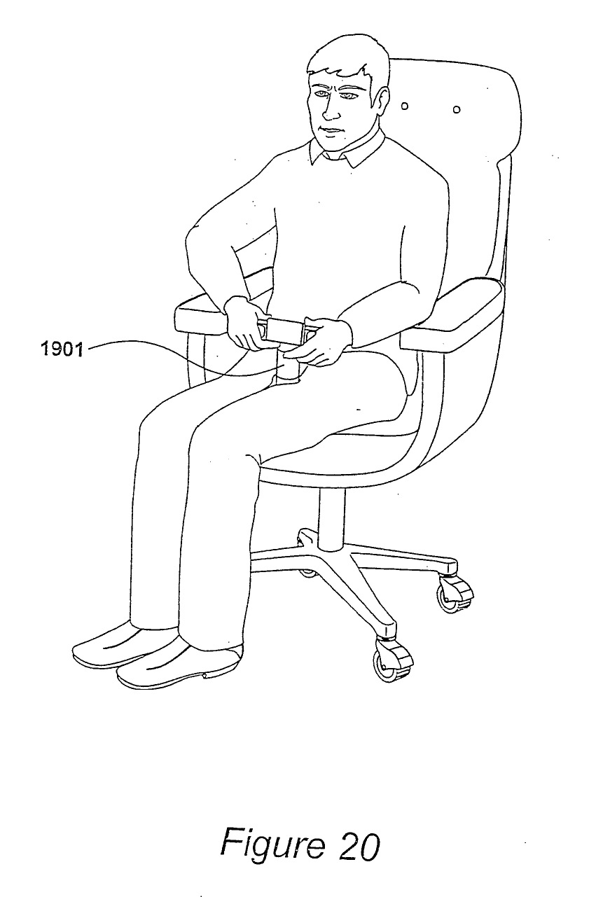

FIG. 20

The configuration shown in FIG. 19 may be used in a situation as shown in FIG. 20. Thus, base plate 1902 is supported by a chair and the deformable input device is thus held down by a user's legs. The control device 1904 is then held in an orientation substantially similar to that of a steering wheel or similar input device thereby providing the user with a realistic and enhanced operation stance thereby significantly enhancing the interaction with the game or program itself; all achieved by use of a relatively inexpensive, durable additional control apparatus.

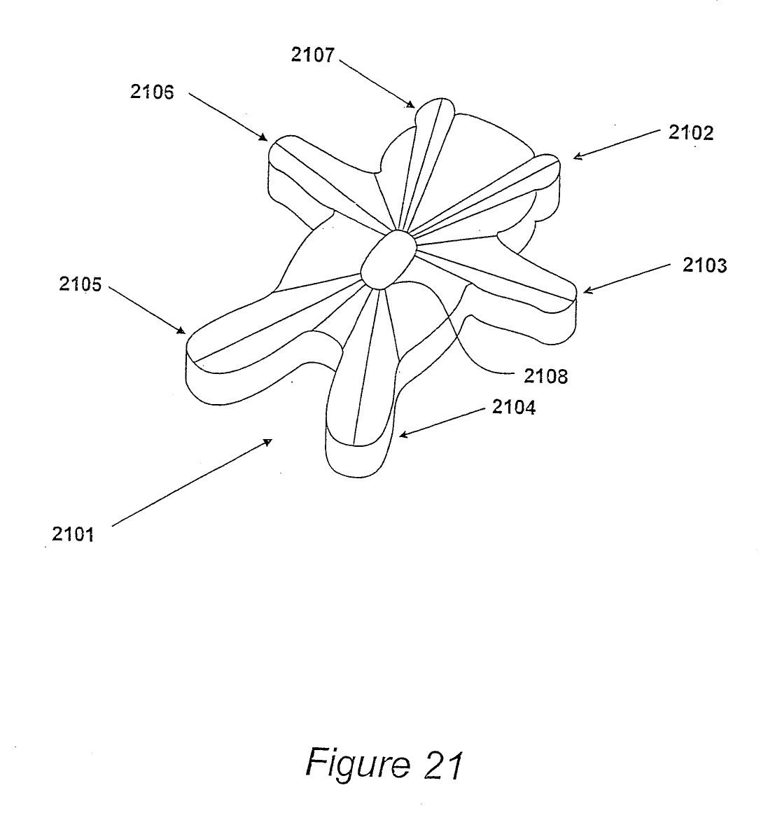

FIG. 21

An alternative application for a deformable input device is illustrated in FIG. 21. Soft toy 2101 takes the form of a teddy bear, and utilises, in this example, a plurality of deformable input devices, indicated at 2102, 2103, 2104, 2105, 2106 and 2107, each comprising three electrical terminals. The input devices 2101, 2102, 2103, 2104, 2105, 2106 are all electrically connected, in this example by means of a conductive ring 2108. The terminals of the input devices are distributed about the soft toy 2101. In the shown arrangement, an input device is located in each region corresponding to an ear of the toy 2101, an arm of the toy 2101 and a leg of the toy 2101. During play with the toy 2101, manipulation of the main body or extremities of the toy 2101 can be detected, and for example used to raise a visual, aural or tactual effect response.

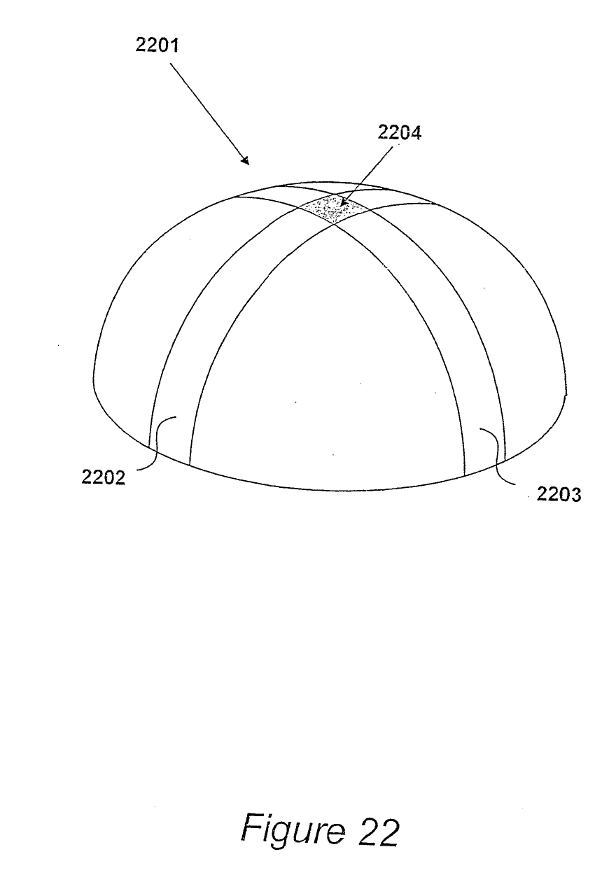

FIG. 22

An alternative shape format for a deformable input device is illustrated in FIG. 22, in the form of a hemisphere. Input device 2201 utilises two strips of electroconductive material 2202 and 2203, operatively coupled with the domed surface of the hemisphere. As shown, each of the conductive tracks 2202, 2203 extend over the domed surface between opposite ends of a diameter of the substantially planar base of the hemispherical input device 2201. The strips 2202, 2203 are arranged substantially perpendicular, with a region of electrical contact, indicated by shaded region 2204, between the two strips 2202, 2203, in the region of the apex of the domed surface. This arrangement and is similar to that of the deformable input device described with reference to, and as illustrated in, FIG. 10, and may utilise a similar scanning sequence during operation.

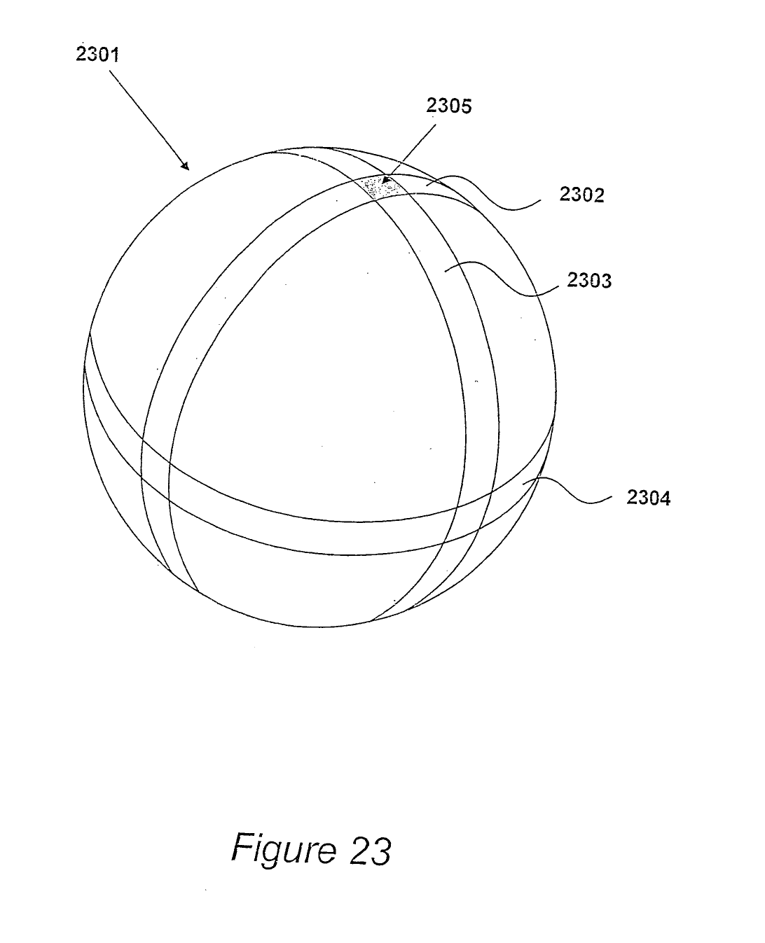

FIG. 23

A further alternative shape format for a deformable input device is illustrated in FIG. 23, in the form of a sphere. Input device 2301 utilises three strips of electroconductive material 2302, 2303 and 2304, operatively coupled with the resilient material forming the main body of the sphere. As illustrated, each of the conductive strips 2302, 2303 and 2304 extend around the circumference of a great circle of the spherical input device 2301, and are arranged such that one is substantially perpendicular to another. The strips 2302, 2303 and 2304 intersect to form six regions of electrical contact around the spherical body, for example in the region indicated by shaded region 2305 through which strips 2302 and 2303 pass.

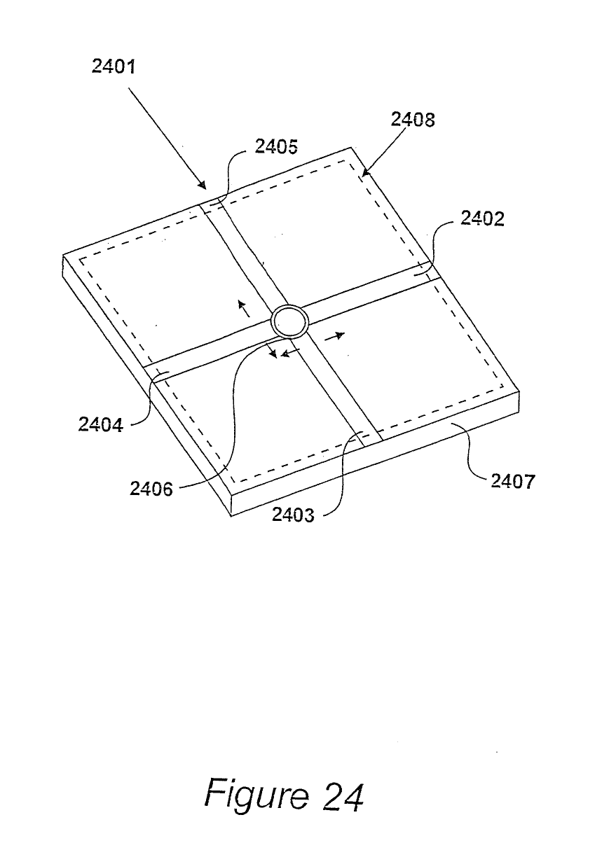

FIG. 24

An alternative embodiment of deformable input device is illustrated in FIG. 24. Input device 2401 takes on a more two-dimensional form. The input device 2401, comprises four strips of elastomeric electroconductive material 2402, 2403, 2404 and 2405, each strip having one end connected to a conductive ring 2406 and the other end connected to a frame 2407. In this example, each of the strips 2402, 2403, 2404, 2405 is attached to a different side of a substantially square frame, as though to divide the square into four smaller squares. This arrangement is similar to that of the deformable input device described with reference to, and as illustrated in, FIG. 10, but in a two-dimensional format. In the relaxed state of this arrangement, the conductive ring 2406 is substantially central within the frame area.

Preferably, frame 2407 is formed from a board of rigid material so as to provide a backing for the conductive strips 2402, 2403, 2404, 2405. In use, the conductive strips 2402, 2403, 2404, 2405 are moved around over the backing frame 2407. Therefore it is preferable to have low friction between the backing frame 2407 and the strips 2402, 2403, 2404, 2405 so that the strips may slide easily under manually applied pressure and to reduce wear. However, a picture frame style arrangement may be utilised.

Input device 2401 may optionally have a stretch cover, indicated generally by dotted line 2408. The stretch cover may underlie or overlie the strips 2402, 2403, 2404, 2405, and may be secured to both the frame 2407 and the strips 2402, 2403, 2404, 2405 or one of these only.

The present embodiment utilises a conductive ring 2406, which when moved from the at rest position causes deformation of the strips 2402, 2403, 2404, 2405 from the at rest condition. In the example shown, the conductive ring 2406 takes the form of an O-ring into which a finger may be inserted to assist movement of the conductive ring 2406 around within the area of the frame 2407. Thus the conductive ring 2406 also functions to enable a user to achieve a more secure grip on the manipulation surface of the input device 2401.

An alternatively type of gripping member, for example in the form of a bump or shaped handle raised from the surface of the input device 2401, may be provided. Such a gripping member would provide a similar function to that of extension portion 1604 of input device 1601 and clamp 1903 of input device 1901, in assisting translation of movement effected by a user to a detectable manipulation of the deformable input device. This feature may be advantageous for users with restricted dexterity.

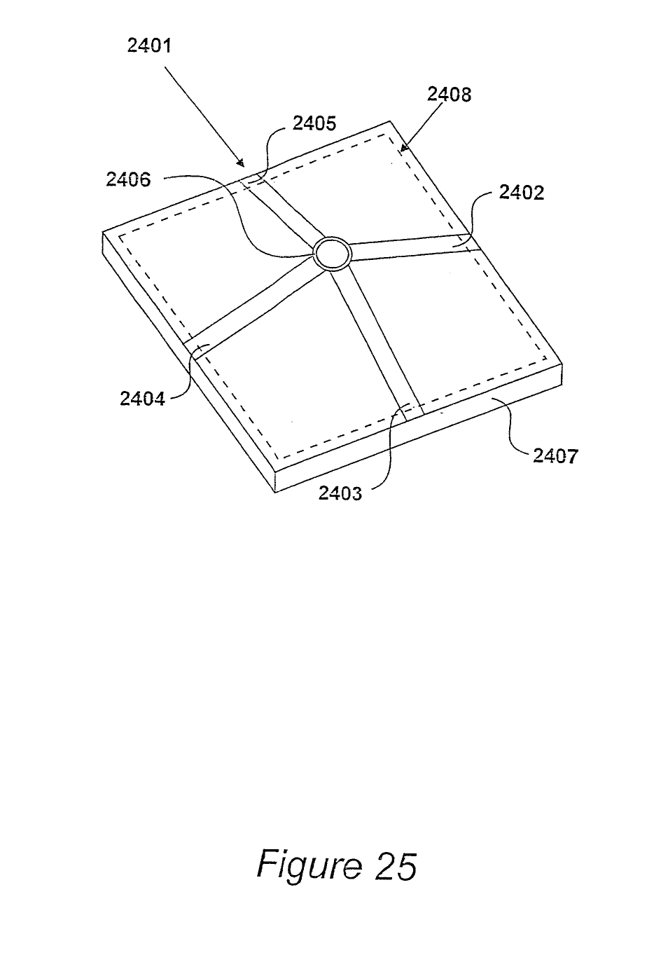

FIG. 25

FIG. 25 shows deformable input device 2401 following movement of the conductive ring 2406 from the at rest position. It can be seen from this Figure that conductive strips 2402 and 2405 are now shorter than in the at rest position and conductive strips 2403 and 2404 are now longer than in the at rest position. Thus, moving the conductive ring 2406 from the at rest position causes each of the strips 2402, 2403, 2404, 2405 to experience internal changes in tension and length. In this way, the input device 2401 is responsive to shear forces. By establishing a voltage gradient across opposed pairs of conductive strips, in this example across strips 2402 and 2404 or strips 2403 and 2404, and taking a voltage reading from one of the other pair of strips, an extent of manually applied pressure and a direction of manipulating movement relative to the at rest condition can be determined.

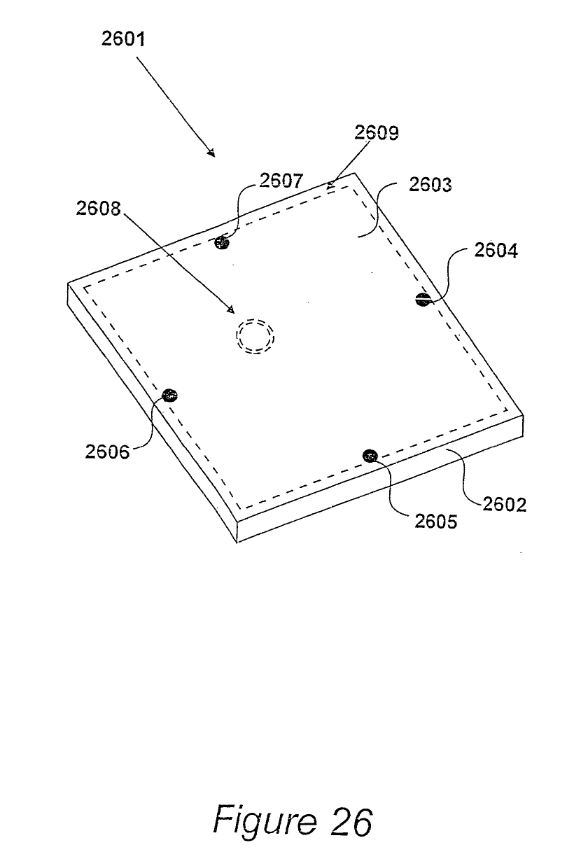

FIG. 26

An alternative embodiment of deformable input device is illustrated in FIG. 26. Input device 2601 takes a similar form to input device 2401, having a similar two-dimensional format and a frame 2602. However, input device 2601 differs in that it utilises a layer of elastic electroconductive fabric 2603 to which four point electrical terminals 2603, 2604, 2605 and 2606 are connected. The four electrical terminals 2603, 2604, 2605, 2606 allow deformation to be detected in two axes, as described above with reference to FIG. 10. This type of arrangement is configured to detect manipulation of any area of the electroconductive material 2603. Dotted line circle 2608 indicates a notional starting position. In addition, the deformable resilient element of the input device 2601 and the electroconductive material of the input device 2601 are both provided by the layer of elastic electroconductive fabric 2603. Thus, these two elements of the deformable input device may be operatively coupled by virtue of the elements being combined in a single layer. Optionally, however, an additional stretch cover, indicated generally by doffed line 2609, may be provided.

In the shown arrangement, the frame 2602 takes the form of a substantially square backing board, with one point contact 2603, 2604, 2605, 2606 positioned substantially half way along each side. With this arrangement, voltage swing is less detectable at the corner regions of the frame area than in the centre of the frame 2602.

This arrangement is suitable for use in applications in which relative rather than absolute positional information is sufficient. Practical applications include use as a sensor, or as a cursor control or menu navigation tool.

1. A manually deformable input device responsive to manually applied pressure, comprising
a deformable resilient element configured to deform in response to said manually applied pressure, operatively coupled with
an electroconductive material applied configured to exhibit changes in conductance (resistance) in response to being stretched; and
an electrical interface device configured to supply electrical current through said electroconductive material via a first terminal and a second terminal, wherein:
a third terminal is connected at an intermediate position; and
said interface device is configured to receive a voltage from said third terminal.

2. An input device according to claim 1, wherein said electroconductive material is applied over said deformable resilient element.

3. An input device according to claim 1, wherein said electroconductive material is embedded within said deformable resilient element.

4. An input device according to claim 1, wherein said deformable resilient element is constructed from a foam or foam-like material, rubber or silicone rubber.

5. An input device according to claim 1, wherein said electroconductive material is a textile fabric.

6. An input device according to claim 5, wherein said textile fabric is a warp knit, a weft knit or a weave that includes conductive fibres.

7. An input device according to claim 1, wherein said electroconductive material is an elastomeric material having electroconductive components therein.

8. An input device according to claim 1, wherein said deformable resilient element and said electroconductive material are provided by an elastomeric electroconductive textile.

9. An input device according to claim 1, wherein the conductance of said electroconductive material increases when said material is stretched.

10. An input device according to claim 1, wherein said interface device is configured to measure a divided voltage between said first terminal and said second terminal.

11. An input device according to claim 1, wherein said interface device is configured to produce an output signal.

12. An input device according to claim 11, wherein said output signal is used to:
control a motor;
provide an input command to a game;
raise an alarm condition;
raise a visual, aural or tactual effect response;
control a cursor;
navigate a menu.

13. An input device according to claim 1, configured to be responsive to translation, rotation, compression or indentation of said deformable resilient element.

14. An input device according to claim 1, comprising a frame.

15. An input device according to claim 1, comprising a gripping member.

16. An input device according to claim 1, further comprising a fourth terminal.

17. A method of detecting deformation of a deformable input device, said input device comprising
a deformable resilient element configured to deform in response to applied pressure, operatively coupled with
an electroconductive material configured to exhibit changes in conductance (resistance) in response to being stretched, and
a first electrical terminal, a second electrical terminal and a third electrical terminal, said third terminal at a position intermediate said first terminal and said second terminal; said method comprising the steps of:
establishing a voltage gradient across said electroconductive material via said first terminal and said second terminal, and
measuring a voltage appearing at said third terminal.

18. A deformable input device substantially as herein described with reference to and as shown in FIGS. 1 to 26 of the accompanying drawings.

19. A method of detecting deformation of a deformable input device substantially as herein described with reference to and as shown in FIGS. 1 to 26 of the accompanying drawings.
